(19) United States
(12) Patent Application Publication
(10) Pub. No.: US 2006/0243520 A1
(43) Pub. Date: Nov. 2, 2006

(54) Screw compressor with an acoustic wave damping device

(75) Inventors: Bernd Hertenstein, Wildberg (DE); Torsten Schoeck, Sindelfingen (DE)

Correspondence Address: REINHART BOERNER VAN DEUREN P.C., 2215 PERRYGREEN WAY, ROCKFORD, IL, 61107, US

(73) Assignee: Bitzer Kuehlmaschinenbau GmbH, Sindelfingen (DE)

(21) Appl. No.: 11/451,709

(22) Filed: Jun. 13, 2006

Related U.S. Application Data
(63) Continuation of application No. PCT/EP04/14013, filed on Dec. 9, 2004.

(30) Foreign Application Priority Data
Dec. 15, 2003 (DE) 103 59 032.3

(51) Int. Cl. F02M 35/00

(52) U.S. Cl. 181/229; 417/312

(57) ABSTRACT

In order to avoid pulsations in a screw compressor comprising an outer housing, a compressor screw housing which is arranged in the outer housing and in which rotor bores for screw rotors are arranged, a drive arranged in the outer housing on one side of the compressor screw housing and a bearing housing arranged in the outer housing on a side of the compressor screw housing located opposite the drive, it is suggested that an acoustic wave damping device having the compressed working medium flowing through it be arranged within the outer housing.

This application is a continuation of International application No. PCT/EP2004/014013 filed on Dec. 9, 2004.

This patent application claims the benefit of International application No. PCT/EP2004/014013 of Dec. 9, 2004 and German application No. 103 59 032.3 of Dec. 15, 2003, the teachings and disclosure of which are hereby incorporated in their entirety by reference thereto.

### BACKGROUND OF THE INVENTION

The invention relates to a screw compressor comprising an outer housing, a compressor screw housing which is arranged in the outer housing and in which rotor bores for screw rotors are arranged, a drive arranged in the outer housing on one side of the compressor screw housing and a bearing housing arranged in the outer housing on a side of the compressor screw housing located opposite the drive.

Screw compressors of this type are known from DE 198 45 993.9-15.

The problem with these compressors is that the working medium compressed by the screw rotors is caused to pulsate with a basic frequency which correlates to the rotational speed of the screw rotors and at least results in stressing due to noise but can possibly lead, in the case of random resonances, to mechanical problems in the subsequent pipe system for the compressed working medium and even to mechanical damage in the pipe system.

The object underlying the invention is, therefore, to avoid pulsations of this type as far as possible.

### SUMMARY OF THE INVENTION

This object is accomplished in accordance with the invention, in a screw compressor of the type described at the outset, in that an acoustic wave damping device which has compressed working medium flowing through it is arranged within the outer housing.

An acoustic wave damping device of this type has the great advantage that, with it, the formation of pressure pulsations can already be suppressed within the outer housing and, therefore, the screw compressor already generates less noise during running and, in addition, essentially no more undesired pulsations whatsoever can occur in the subsequent lines for the compressed working medium.

With this concept it would be conceivable to damp pressure pulsations in the compressed working medium by means of an acoustic wave damping device formed by different chambers of the outer housing.

The arrangement of the acoustic wave damping device in the outer housing is particularly advantageous when the acoustic wave damping device is arranged in an interior space of the outer housing accommodating the compressed working medium.

In this case, it is, for example, possible to configure the acoustic wave damping device in a considerably more simple manner from a constructional point of view since this need no longer be designed as a pressure vessel since approximately the same pressure is present in the interior of the acoustic wave damping device and around it, in contrast to the case where the acoustic wave damping device is arranged outside the outer housing since, in this case, the acoustic wave damping device, since it guides compressed working medium, has to be designed as a pressure tank which withstands the difference in pressure between the pressure of the compressed working medium and the pressure of the surroundings.

The pressure pulsations may be damped particularly efficiently when the compressed working medium passes directly into the acoustic wave damping device from an outlet channel for the compressed working medium.

It would, for example, be conceivable to design the outlet channel such that the acoustic wave damping device can be arranged in it.

For reasons of space it is, however, expedient when the acoustic wave damping device is arranged so as to follow on directly from the outlet channel for the compressed working medium and, therefore, the outlet channel can be designed in a space-saving manner.

With respect to the connection to the outlet channel, the most varied of possibilities are conceivable. One expedient solution provides for the acoustic wave damping device to be connected to the outlet channel with an inlet connection piece.

With respect to the course of the outlet channel, no further details have so far been given. It would, for example, be conceivable to provide the outlet channel in the compressor screw housing and to guide it out of the compressor screw housing in the area thereof.

A spatially expedient solution provides for the outlet channel for the compressed working medium to extend in the bearing housing which is arranged on a side of the compressor screw housing located opposite the drive so that the outlet channel can be easily guided in a suitable manner.

The acoustic wave damping device could be arranged, for example, next to the bearing housing or to the side of the bearing housing.

A solution which is particularly favorable from a constructional point of view does, however, provide for the acoustic wave damping device to be arranged on a side of the bearing housing facing away from the compressor screw housing and, therefore, for it to be possible to arrange the damping device within the outer housing in a simple manner.

It is, spatially, particularly expedient in this respect when the acoustic wave damping device is arranged between the bearing housing and an end-side closure of the outer housing.

With respect to the design of the acoustic wave damping device itself, no further details have been given in conjunction with the preceding embodiments.

One advantageous embodiment, for example, provides for the acoustic wave damping device to have an acoustic wave damping device housing, into which a damping device pipe is inserted which has a jump in cross section in relation to the surroundings on its inlet side and its outlet side.

With such a damping device pipe, the undesired pressure pulsations may be advantageously damped as a result of the phenomenon of the reflection of pressure pulsations at the open end of the damping device pipe.

When a damping device pipe is used, a favorable damping is provided either at the inlet side of the acoustic wave damping device or at the outlet side. One expedient solution provides for the damping device pipe to be arranged on the outlet side of the acoustic wave damping device housing.

The damping device pipe may be adjusted to different frequencies.

One particularly expedient solution provides for the damping device pipe to have a length which corresponds approximately to a quarter of a wavelength of a pressure pulsation in the working medium to be compressed at a basic frequency of the screw compressor. The basic frequency results as a frequency correlated to a driving speed of the screw rotors.

A particularly favorable damping effect may be achieved when the compressed working medium is guided in the damping device housing in a meandering manner and, in this respect, has to run in the damping device housing, in particular, in a meandering manner in order to exit from the acoustic wave damping device again.

With respect to the arrangement of the acoustic wave damping device housing, it is particularly favorable when this is arranged between the bearing housing and the end-side closure of the outer housing.

A particularly good decoupling of the pressure pulsations in relation to the surroundings may be achieved when the acoustic wave damping device is arranged free from connection to the outer housing and, therefore, no noise can be transferred to the outer housing via the connection between the acoustic wave damping device and the outer housing.

In this case, the acoustic wave damping device is preferably supported on the bearing housing.

This may be brought about either due to the fact that the acoustic wave damping device is fixed in position via the connection to the outlet channel or by additional holding elements.

In conjunction with the preceding description, it has not been explained in greater detail how the compressed working medium is intended to be guided in the outer housing after passing through the acoustic wave damping device.

One expedient solution provides for the acoustic wave damping device to open into an interior space of the outer housing.

In order to be able to carry out a separation of oil, it is preferably provided for the acoustic wave damping device to discharge the compressed working medium into a distribution chamber of the interior space, following which the compressed working medium flows through an oil separator element.

The oil separator element may be arranged in the most varied of ways. One expedient solution provides for the interior space in the outer housing to be divided by the oil separator element into a distribution chamber and a flow-off chamber, wherein the compressed working medium flows from the flow-off chamber to an outlet chamber.

The oil separator element may be arranged within the outer housing in conjunction with the acoustic wave damping device particularly favorably when the acoustic wave damping device penetrates the oil separator element and so it is possible to arrange the oil separator element between the bearing housing and the closure of the outer housing, wherein the oil separator element expediently extends over the entire cross section of the outer housing in this area in order to have as large a cross sectional surface area as possible which is, however, reduced by the cross sectional surface area, with which the acoustic wave damping device penetrates the oil separator element.

With respect to as good a damping as possible and with respect to the interception of pressure peaks, a constriction in the flow cross section is preferably provided in the outlet channel.

Pressure peaks may be intercepted particularly favorably when the constriction in the flow cross section is designed such that the compressed working medium flows through this in the form of a meander.

With respect to the outer housing, no further details have been given thus far.

The outer housing can, in principle, be designed in the most varied of ways, for example, be composed of several housing shells with end-side covers.

One particularly expedient solution provides for the outer housing to comprise a central section accommodating the compressor screw housing and an end section on the pressure side following the central section.

In this respect, the end section on the pressure side is preferably designed as a housing capsule extending from the central section.

Such a housing capsule is preferably configured as a whole so as to be compression resistant and is connected to the central section via a flange connection.

In this respect, the housing capsule is preferably designed such that not only the bearing housing but also the acoustic wave damping device and, in particular, also the oil separator element are arranged in it.

Additional features and advantages of the invention are the subject matter of the following description as well as the drawings illustrating one embodiment.

### BRIEF DESCRIPTION OF THE DRAWINGS

FIG. 1 shows a longitudinal section along line 1-1 in FIG. 4;

FIG. 2 shows a longitudinal section along line 2-2 in FIG. 4;

FIG. 3 shows a longitudinal section along line 3-3 in FIG. 4;

FIG. 4 shows a plan view of the compressor according to the invention in the direction of arrow A in FIGS. 1 to 3;

FIG. 5 shows a perspective illustration of a screw compressor according to the invention with a housing capsule of the outer housing on the pressure side removed so that a bearing housing and an acoustic wave damping device are apparent;

FIG. 6 shows an illustration of the acoustic wave damping device of the screw compressor according to the invention in a side view and

FIG. 7 shows a longitudinal section through the acoustic wave damping device illustrated in FIG. 6.

### DETAILED DESCRIPTION OF THE INVENTION

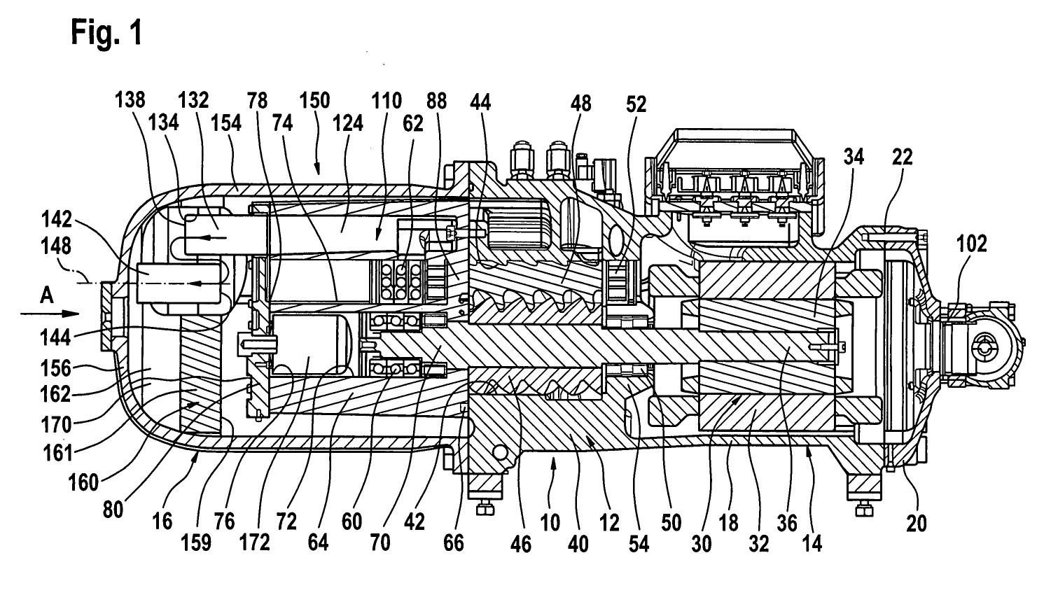

One embodiment of a screw compressor according to the invention, illustrated in FIG. 1, comprises an outer housing which is designated as a whole as 10 and is built up of a central section 12, an end section 14 on the motor side and an end section 16 on the pressure side.

The end section 14 on the motor side is, for example, formed by a first housing shell 18 which is integrally formed on the central section 12 in one piece and is closed by a first housing cover 20 which is releasably connected to the first housing shell 18 via a flange connection 22.

A drive motor designated as a whole as 30 is arranged in the end section 14 on the motor side and this drive motor is designed, for example, as an electric motor which has a stator 32 which is held in the first housing shell 18 and encloses a rotor 34, wherein the rotor 34 is seated on a drive shaft designated as a whole as 36.

A compressor screw housing designated as a whole as 40 is provided in the central section 12 of the outer housing 10 and is preferably integrally formed on the central section 12 in one piece and has rotor bores 42 and 44 for accommodating screw rotors 46 and 48 which are rotatable about axes parallel to one another. The screw rotor 46 is, for example, seated on the drive shaft 36 which extends away from the stator 32 and passes through the screw rotor 46.

The rotatable mounting of the screw rotors 46 and 48 is brought about on a side thereof facing the drive motor 30 via first rotary bearings 50 and 52 which are seated in a first bearing housing 54 which is integrally formed on the compressor screw housing 40 in one piece on the side facing the drive motor 30.

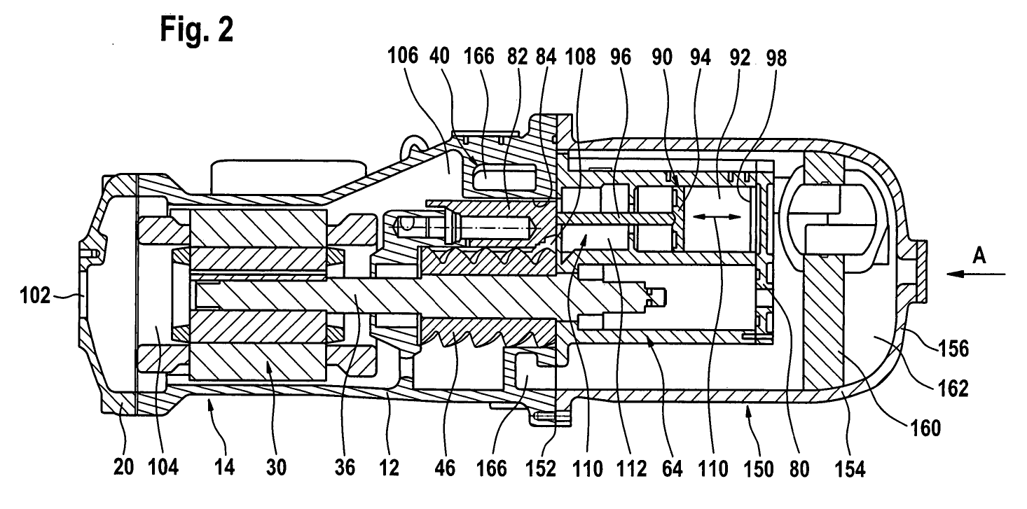

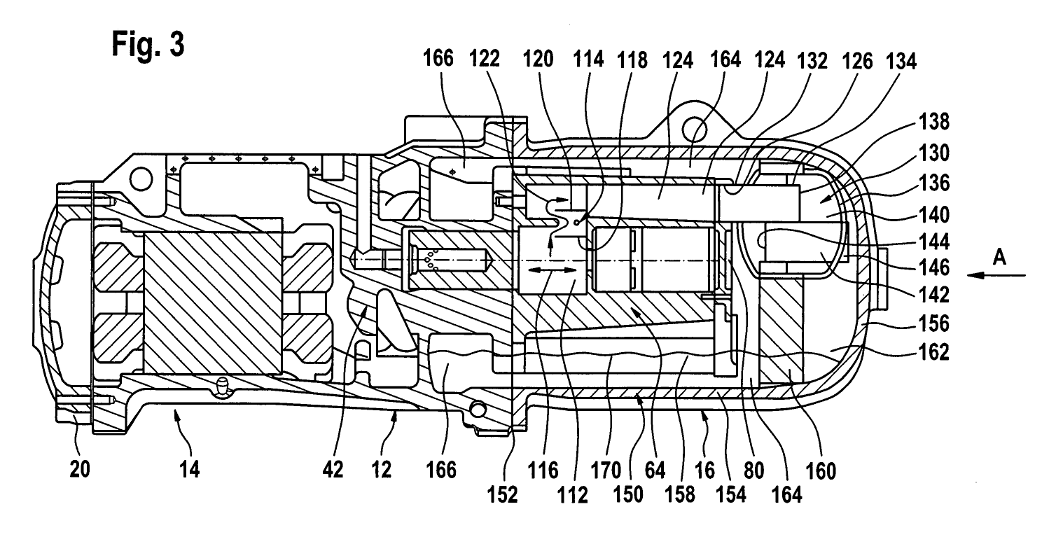

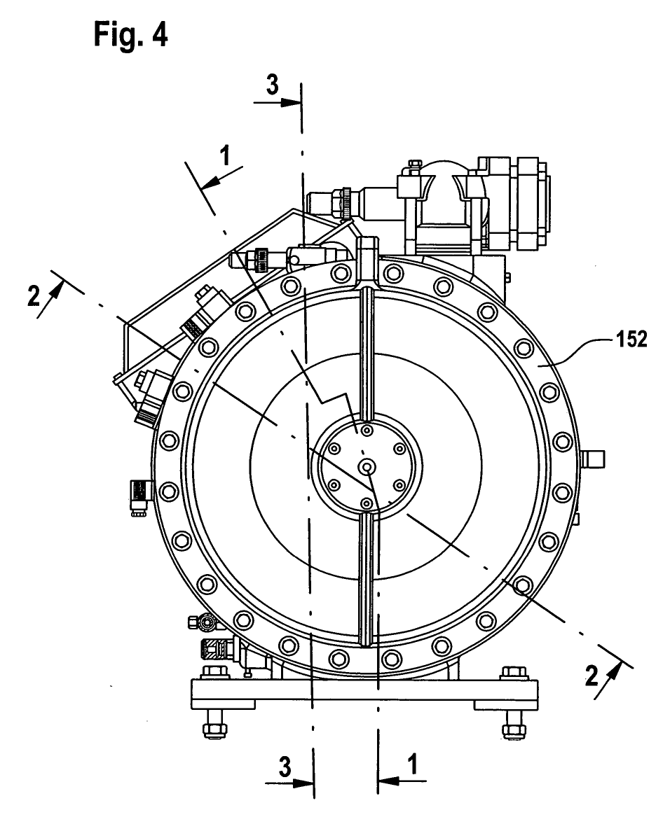

The screw rotors 46 and 48 are mounted on a side facing away from the drive motor 30 via two rotary bearings 60 and 62 which are arranged in a second bearing housing 64 which is releasably held on the compressor screw housing 40 on its side facing away from the drive motor 30 via a flange connection 66 on the compressor screw housing 40, wherein the second bearing housing 64 also has, for its part, a wall 68 which terminates the rotor bores 42, 44 on the pressure side and is penetrated only by stub shafts for the mounting of the screw rotors 46, 48 which lead to the second rotary bearings 60 and 62, wherein only the stub shaft 70 of the drive shaft 36 is apparent in FIGS. 1 and 2.

The rotary bearings 60 and 62 are preferably seated in bearing recesses 72 and 74 which are provided in the second bearing housing 64 and have on one side facing away from the compressor screw housing 40 openings 76 and 78 which can be closed by a cover plate 80 of the second bearing housing 64, wherein the rotary bearings 60 and 62 can be inserted into the bearing recesses 72 and 74 via the openings 76 and 78.

As is apparent from the section according to FIG. 2, a control slide 82 is also provided in the compressor screw housing 40 in a slide bore 84 and this can be displaced in a direction parallel to the axes of rotation of the screw rotors 46 and 48, namely controllable by an adjusting cylinder which is designated as a whole as 90, is arranged in the second bearing housing 64 and comprises an adjusting piston 94 which is displaceable in a cylinder chamber 92 of the second bearing housing 64 and is connected to the control slide 82 via a piston rod 96.

The cylinder chamber 92 is likewise provided with an opening 98 which can be closed by the cover plate 80 of the second bearing housing 64.

In the case of the screw compressor according to the invention, working medium to be compressed is supplied to an inlet chamber 104, which is arranged within the end section 14 on the motor side and in which the electric motor 30 is also arranged, via an inlet opening 102 provided in the first housing cover 20 and so the electric motor 30 is cooled by the working medium flowing through the inlet chamber 104.

The working medium flows out of the inlet chamber 104 into an inlet area 106 which is provided on a side of the compressor housing 40 facing the drive motor 30 and supplies the working medium to the screw rotors 46 and 48 for the purpose of compression.

The working medium compressed by the screw rotors 46 and 48 is discharged from the screw rotors 46 and 48 into an outlet area 108 in the compressor screw housing 40 which is arranged on a side of the compressor screw housing 40 facing away from the drive motor 30 and passes from the outlet area 108 into an outlet channel 110 which is arranged in the second bearing housing 64 and is formed first of all by a slide receiving means 112 which follows on from the slide bore 84 and which the control slide 82 enters in slide positions which correspond to a lower compressor capacity than the maximum capacity.

The slide receiving means 112 is, in addition, penetrated by the piston rod 96 guided from the adjusting piston 94 to the control slide 82.

The outlet channel 110 leads from this slide receiving means 112 via an outlet window 114, which is arranged to the side of the slide receiving means 112 and has the compressed working medium flowing through it in a direction transverse to an adjusting direction 116 of the control slide 82, to a discharge channel 124.

The outlet window 114 is preferably provided with flow deflection walls 118 and 120 which are arranged on both sides thereof, prevent any direct flow of the compressed working medium transversely to the adjusting direction 116 and force the compressed working medium to flow through the outlet window 114 in the form of a meandering flow path 122 before the compressed working medium enters the discharge channel 124 in the second bearing housing 64 which extends in the direction of the cover plate 80, namely to a discharge opening 126 in the cover plate 80.

The flow deflection walls 118 and 120 in the area of the outlet window 114 serve the purpose of damping any propagation of strong pressure peaks between the slide receiving means and the discharge channel 124 as a result of the meandering course of the flow path 122.

The discharge opening 126 is followed by an acoustic wave damping device, designated as a whole as 130, with its inlet connection piece 132, wherein the inlet connection piece 132 is part of an inlet pipe 134 which extends into a damping device housing 136 of the acoustic wave damping device proceeding from the inlet connection piece 132 engaging in the discharge opening 126 so as to close it in a sealed manner and has an opening 138 which is located within the damping device housing 136 and at which the compressed working medium guided in the inlet pipe 134 experiences a jump in cross section, for example, by more than a factor of 2 when it enters an interior space 140 of the damping device housing 136.

In addition, the acoustic wave damping device 130 comprises a damping device pipe 142 which penetrates the damping device housing 136 and has an inner opening 144 as well as an outer opening 146. The compressed working medium spreading in the interior space 140 of the damping device housing 136 enters the inner opening 144 of the damping device pipe 142 from the interior space 140 with a jump in cross section of more than a factor of 2 and flows through this pipe in the direction of the outer opening 146 located outside the damping device housing 136.

The length of the damping device pipe 142 between the inner opening 144 and the outer opening 146 amounts to approximately a quarter of the wavelength of the basic pulsation forming as a result of the rotating screw rotors 46 and 48 and correlated to their rotational speed and so the variations in pressure occurring due to the basic pulsation in the working medium on the pressure side will be damped by the acoustic wave damping device 130 with the damping device pipe 142 before this working medium exits from the outer opening 146 of the acoustic wave damping device 130.

The acoustic wave damping device 130 is preferably designed such that the inlet pipe 134 and the damping device pipe 142 extend approximately parallel to one another and partially overlap with their extensions in their longitudinal direction so that the opening 138 of the inlet pipe 134 and the inner opening 144 of the damping device pipe 142 are arranged so as to be offset radially and axially with respect to a longitudinal direction 148 of the damping device pipe 142 and, consequently, the compressed working medium must flow in the damping device housing 136 in the form of a meander from the opening 138 of the inlet connection piece 132 to the inner opening 144 of the damping device pipe 142.

The damping effect of the acoustic wave damping device 130 may be improved, in addition, when, when seen in the longitudinal direction 148, end walls 135 and 137 of the damping device housing 136 have a distance from one another which is likewise in the order of magnitude of a quarter of the wavelength of the pressure pulsations propagating with the basic frequency, wherein the distance may preferably deviate by up to 25%, even better up to 15% from a quarter of the wavelength.

Since oil can likewise already be separated in the damping device housing 136, in particular, on account of the meandering guidance of the compressed working medium, the damping device housing 136 is provided on its side located at the lowest point in the direction of gravity with an opening 149, from which oil separated in the damping device housing 136 can flow off.

The end section 16 on the pressure side is, in the embodiment illustrated, formed by a housing capsule 150 which is connected to the central section 12 with a flange connection 152 and, proceeding from the central section, extends away from it on a side located opposite the drive motor 30 with a capsule shell 154 which surrounds both the second bearing housing 64 and the acoustic wave damping device 130 on the outside and is closed by a capsule base 156 on a side located opposite the flange connection 152.

The housing capsule 150 encloses an interior space 158, through which the compressed working medium passes and in which the second bearing housing 64 and the acoustic wave damping device 130 are arranged, wherein the interior space 158 is divided by an oil separator 160, which extends approximately parallel to the capsule base 156 and to the cover plate 80, into a distribution chamber 162 which is located between the oil separator 160 and the capsule base 156 and a flow-off chamber 164 which is located between the oil separator 160 and the compressor screw housing 40.

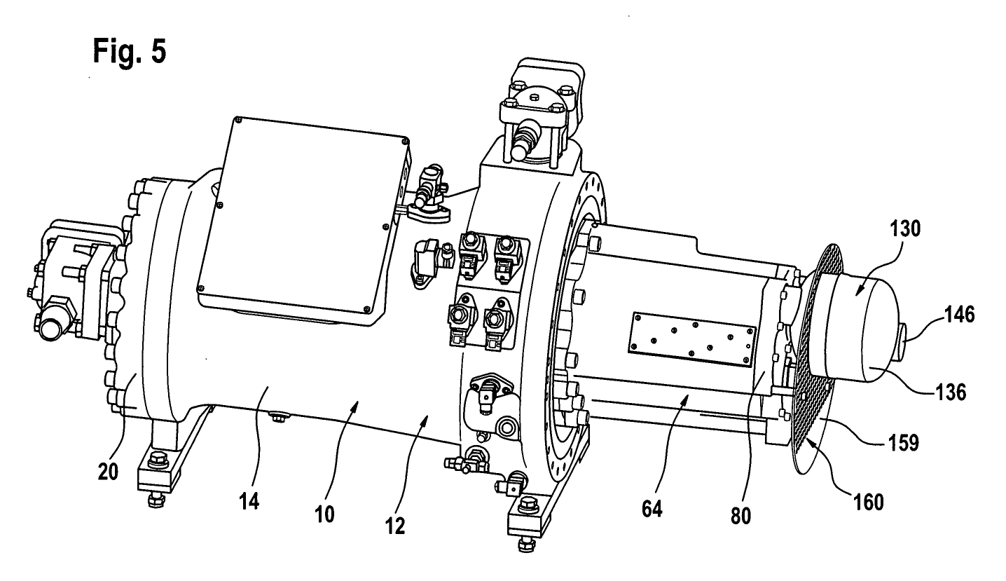

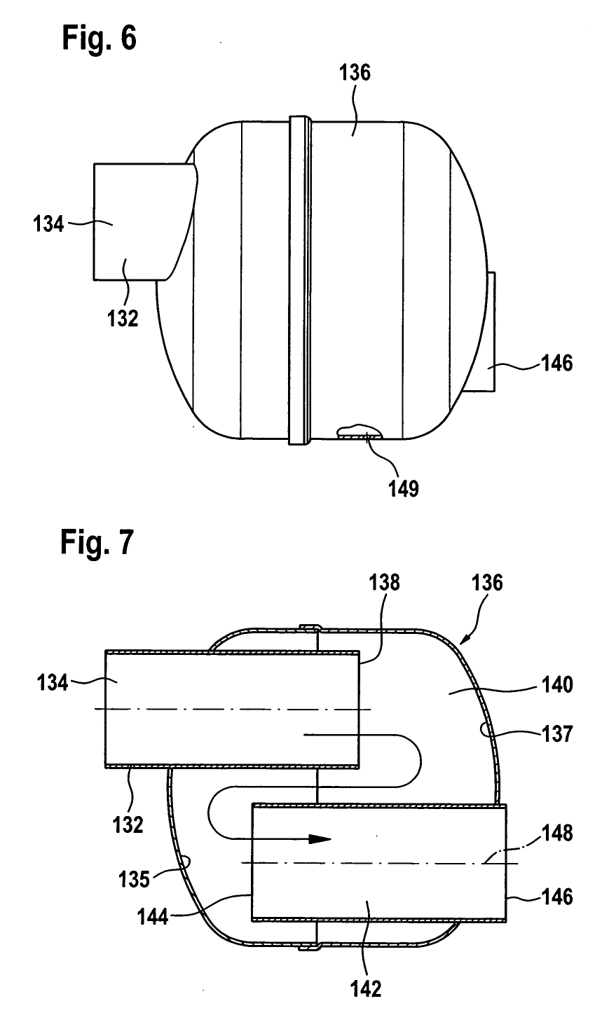

As illustrated in FIGS. 1 and 5 in detail, the oil separator 160 comprises a supporting element 159 in the form of a perforated metal sheet which is penetrated, for its part, by the acoustic wave damping device 130 and supports the acoustic wave damping device 130 in the area of its damping device housing 136.

The supporting element 159 is, for its part, connected rigidly to the bearing housing 64, in particular, the cover plate 80 thereof, for example, via spacer bolts.

In addition, the oil separator 160 comprises a layer consisting of a knitted, interlaced or woven fabric consisting of metal or plastic which is held in position by the supporting element 159 and has the task of combining oil mist entrained in the compressed working medium to form drops and, therefore, to contribute to the separation of oil out of the compressed working medium.

Drops of oil are, therefore, already formed while the working medium is flowing through the oil separator 160 and these drops of oil either already settle in the oil separator 160 itself in the direction of gravity and collect by following the direction of gravity or are likewise separated from the compressed working medium on account of the effect of gravity after flowing through the oil separator.

The acoustic wave damping device 130 is, in the solution according to the invention, arranged such that it penetrates the oil separator 160, wherein the inlet connection piece 132 is located on the one side of the oil separator 160 and is surrounded by the flow-off chamber 164 while the outer opening of the damping device pipe 142 opens into the distribution chamber 162, in which the compressed working medium is distributed with a jump in cross section of more than a factor of 2 over a large flow cross section which essentially corresponds to an interior cross section of the capsule shell 154 minus the cross sectional area taken up by the acoustic wave damping device 130 where it penetrates the oil separator 160 and so the compressed working medium can flow through the oil separator 160 with a large flow cross section in the direction of the flow-off chamber 164 in order to then be supplied from the flow-off chamber 164 to an outlet chamber 166 which is provided in the area of the central section 12 and engages around the compressor screw housing 40 at least partially and which leads to an outlet opening provided in the outer housing 10.

The oil separated by the oil separator 160 collects in the form of an oil sump 170 which extends over a lower area of the distribution chamber 162, a lower area of the flow-off chamber 164 and a lower area of the outlet chamber 166.

The oil is taken up from the oil sump 170 and thereby filtered by an oil filter 172 which is arranged in the bearing recess 72 of the second bearing housing 64 in order to save on space, wherein a supply and discharge of oil to and from the oil filter 172 preferably takes place via the cover plate 80.

1. Screw compressor comprising
an outer housing,
a compressor screw housing arranged in the outer housing, rotor bores for screw rotors being arranged in said compressor screw housing,
a drive arranged in the outer housing on one side of the compressor screw housing,
and a bearing housing arranged in the outer housing on a side of the compressor screw housing located opposite the drive,
wherein an acoustic wave damping device having the compressed working medium flowing through it is arranged within the outer housing.

2. Screw compressor as defined in claim 1, wherein the acoustic wave damping device is arranged in an interior space of the outer housing accommodating the compressed working medium.

3. Screw compressor as defined in claim 1, wherein the compressed working medium passes directly into the acoustic wave damping device from an outlet channel for the compressed working medium.

4. Screw compressor as defined in claim 3, wherein the acoustic wave damping device is arranged so as to follow on directly from the outlet channel for the compressed working medium.

5. Screw compressor as defined in claim 3, wherein the acoustic wave damping device is connected to the outlet channel with an inlet connection piece.

6. Screw compressor as defined in claim 1, wherein the outlet channel for the compressed working medium extends in the bearing housing.

7. Screw compressor as defined in claim 1, wherein the acoustic wave damping device is arranged on a side of the bearing housing facing away from the compressor screw housing.

8. Screw compressor as defined in claim 7, wherein the acoustic wave damping device is arranged between the bearing housing and an end-side closure of the outer housing.

9. Screw compressor as defined in claim 1, wherein the acoustic wave damping device has an acoustic wave damping device housing, a damping device pipe having a jump in cross section in relation to the surroundings on its inlet side and its outlet side being inserted into said housing.

10. Screw compressor as defined in claim 9, wherein the damping device pipe is arranged on the outlet side of the acoustic wave damping device housing.

11. Screw compressor as defined in claim 9, wherein the damping device pipe has a length corresponding approximately to a quarter of a wavelength of a pressure pulsation in the working medium to be compressed at a basic frequency of the screw compressor.

12. Screw compressor as defined in claim 11, wherein the basic frequency of the screw compressor is correlated to the driving speed of the screw rotors.

13. Screw compressor as defined in claim 9, wherein the compressed working medium is guided in the damping device housing in a meandering manner.

14. Screw compressor as defined in claim 9, wherein the acoustic wave damping device housing is arranged between the bearing housing and the end-side closure of the outer housing.

15. Screw compressor as defined in claim 1, wherein the acoustic wave damping device is held free from connection to the outer housing.

16. Screw compressor as defined in claim 1, wherein the acoustic wave damping device opens into an interior space of the outer housing.

17. Screw compressor as defined in claim 16, wherein the acoustic wave damping device discharges the compressed working medium into a distribution chamber in the interior space, the compressed working medium flowing through an oil separator element following said distribution chamber.

18. Screw compressor as defined in claim 17, wherein the interior space in the outer housing is divided by the oil separator element into the distribution chamber and a flow-off chamber.

19. Screw compressor as defined in claim 18, wherein the acoustic wave damping device penetrates the oil separator element.

20. Screw compressor comprising an outer housing, a compressor screw housing arranged in the outer housing, rotor bores for screw rotors being arranged in said compressor screw housing, a drive arranged in the outer housing on one side of the compressor screw housing and a bearing housing arranged in the outer housing on a side of the compressor screw housing located opposite the drive, wherein the compressed working medium flows through a constriction in the flow cross section in the outlet channel.

21. Screw compressor as defined in claim 20, wherein the compressed working medium flows through the constriction in the flow cross section in the form of a meander.

22. Screw compressor as defined in claim 1, wherein the outer housing comprises a central section accommodating the compressor screw housing and an end section on the pressure side following the central section.

23. Screw compressor as defined in claim 22, wherein the end section on the pressure side is designed as a housing capsule extending from the central section.

24. Screw compressor as defined in claim 21, wherein the housing capsule is of a compression resistant design and is connected to the central section via a flange connection.
